(19) United States
(12) Patent Application Publication
(10) Pub. No.: US 2025/0215874 A1
(43) Pub. Date: Jul. 3, 2025

(54) MONITORING APPARATUS, ARRANGEMENT AND METHOD FOR A SPRINKLER PUMP UNIT

(71) Applicant: MECON GmbH, Overath (DE)

(72) Inventors: Joachim Böke, Düsseldorf (DE); Frank Friede, Ratzeburg (DE); Philipp Jauer, Lübeck (DE)

(73) Assignee: MECON GmbH, Overath (DE)

(21) Appl. No.: 19/001,113

(22) Filed: Dec. 24, 2024

(30) Foreign Application Priority Data
Dec. 29, 2023 (DE) 102023136854.0

(51) Int. Cl. F04B 51/00; G01B 21/16

(52) U.S. Cl. CPC F04B 51/00; G01B 21/16

(57) ABSTRACT

A monitoring apparatus for a sprinkler pump unit has at least one first measuring unit and an evaluation unit. The sprinkler pump unit has a drive, a pump and an installation base. The drive is mounted to the installation base by a first mounting, the pump is mounted to the installation base by a second mounting, and the installation base is mounted to a floor by a third mounting. The monitoring apparatus is configured and adapted to determine a position change of at least one reference point on the pump and/or the drive relative to at least one fixed reference point by the at least one first measuring unit. A corresponding method and an arrangement with a sprinkler pump unit is also provided.

### CROSS-REFERENCE TO RELATED APPLICATION

This application claims priority to German Patent Application No. 102023136854.0, filed Dec. 29, 2023, which is hereby incorporated by reference in its entirety.

### FIELD OF THE INVENTION

The present invention relates to a monitoring apparatus for a sprinkler pump unit, comprising at least one first measuring unit and an evaluation unit, and the sprinkler pump unit comprising a drive, a pump and an installation base, the drive being mounted to the installation base by a first mounting and the pump by a second mounting and the installation base being mounted to the floor by a third mounting.

The invention further relates to an arrangement with a sprinkler pump unit, the sprinkler pump unit comprising a drive, a pump and an installation base, the drive being mounted to the installation base by a first mounting and the pump by a second mounting and the installation base being mounted to the floor by a third mounting.

Furthermore, the invention relates to a method for monitoring a sprinkler pump unit with a monitoring apparatus, the monitoring apparatus comprising at least one first measuring unit and an evaluation unit, the sprinkler pump unit comprising a drive, a pump and an installation base, the drive being mounted to the installation base by a first mounting and the pump by a second mounting and the installation base being mounted to the floor by a third mounting.

### BACKGROUND OF THE INVENTION

Such monitoring apparatuses, arrangements and methods are used in particular in fire extinguishing systems. The sprinkler pump units installed in such fire extinguishing systems serve to supply the extinguishing system with extinguishing fluid in the event of a fire. To ensure correct operation of the sprinkler pump unit, it is necessary in particular that the pump and drive are always correctly aligned.

For this reason, the NPFA 20 guidelines and FM Data Sheet 3-07 contain well-defined specifications for the assembly of pump units. Particular attention is paid to the alignment of the coupling of the pump and the drive. Such alignment can be carried out during assembly with the aid of templates, for example. Metrological alignment with lasers is also used for this purpose.

Prior to the pilot operation of the pump unit, data sheet FM 2-81 for the inspection, testing and maintenance of fire protection systems requires a visual inspection for the test of pumps in order to identify loosened, rusted, corroded or damaged pump-securing or drive-securing bolts.

Document WO 03/089875 A1 describes a method and an apparatus which is adapted to measure the relative position of a first component and a second component by means of a first measuring unit and a second measuring unit. The apparatus comprises a first and second mount for attaching the first and second measuring units, respectively, to a housing that is part of the first component and the second component respectively. Each measuring unit is firmly mounted on a rotatable element. The measuring units are suitable for measuring the relative axis position of the first component in relation to the second component in a first and in a second operating state of the first component and of the second component.

A disadvantage of the method and apparatus known from the prior art is that they can only be used to monitor the relative alignment of the axis positions between two components. In other words, it is only possible to monitor the angular position between two axes. Any other change in the relative position between the two components, for example in the case of a purely translational position change, cannot be detected at all with the known method and apparatus. Furthermore, monitoring only ever takes place between two components, which means that changes in the alignment and position of multiple components are not detected either. Another disadvantage is that a laser-based measuring system is used to detect the alignment of the axis positions. Such optical measuring systems require complex equipment.

### SUMMARY OF THE INVENTION

It is therefore the object of the present invention to propose a monitoring apparatus that reliably ensures, as far as possible, that any position change of one or more components of a sprinkler pump unit is detected with a minimum of equipment. The object further consists in proposing a corresponding method. It is also the object of the present invention to provide a corresponding arrangement which allows a pump test run to be carried out reliably.

The object is achieved by a monitoring apparatus with the features mentioned at the outset in that the monitoring apparatus is configured and adapted to determine a position change of at least one reference point on the pump and/or the drive relative to at least one fixed reference point, i.e. to a reference point outside the sprinkler pump unit, by means of said at least one first measuring unit. This makes it possible to reliably detect and monitor position changes within the sprinkler pump unit at all times with relatively little equipment. Determining a position change relative to the at least one fixed reference point has the advantage that any possible undesired position change relative to this reference point is detected. In other words, the aim of the present invention is to monitor at all mounting or installation levels. These mounting levels are, in particular, the levels: installation base—drive, installation base—pump and installation base—floor. Even though multiple mounting levels are monitored, the monitoring apparatus according to the invention only requires little metrological complexity and can therefore also be realised at low cost.

An expedient embodiment of the invention is characterised in that the monitoring apparatus for determining the position change is configured and adapted to determine a first distance change value Δd1 of the at least one reference point on the pump and/or a second distance change value Δd2 of the at least one reference point on the drive relative to the at least one fixed reference point, the evaluation unit further being configured and adapted to compare the first distance change value Δd1 and/or the second distance change value Δd2 with a predetermined reference distance change value Δref, and, if the inequalities |Δd1|>Δref and/or |Δd2|>Δref are satisfied, to generate the first distance change value Δd1 as a first deviation value Δa1 and/or the second distance change value Δd2 as a second deviation value Δa2, and/or to generate a deviation signal. Position changes can thus be reliably detected and monitored. By means of the respective distance change values Δd1, Δd2, it is possible to quantitatively detect the magnitude of a position change that has occurred. In the context of the present invention, quantitative detection is understood to mean that at least one corresponding numerical value is assigned to the magnitude of a position change that has occurred. In other words, representative measurements can be detected as distance change values Δd1, Δd2 that can be used to determine a position change, at least qualitatively. The numerical value therefore does not necessarily have to correlate with the position change actually detected but can be defined by a predetermined assignment rule. Advantageously, the numerical value correlates with the detected position change, for example through a proportional assignment between the size of the position change and the numerical value. The monitoring apparatus is preferably adapted to detect the “zero position”, i.e. the state in which all components of the sprinkler pump unit are correctly aligned and are in the desired positions. In this state, the respective distance change values Δd1, Δd2 each have a value of zero. A possible position change is quantified by the monitoring apparatus using the respective distance change values Δd1, Δd2.

Advantageously, the evaluation unit is also adapted to compare the respective distance change values Δd1, Δd2 with a predefined reference value Δref. This reference value Δref thus serves as a threshold value so that small amounts of the distance change values Δd1, Δd2 that are below this value are not evaluated as a positional deviation. Only when the amounts of the distance change values Δd1, Δd2 each exceed the reference value Δref does the evaluation unit evaluate this as a relevant position change and subsequently generate the said distance change values and/or the deviation signal.

A further expedient embodiment of the invention is characterised in that the monitoring apparatus is adapted to determine the first distance change value Δd1 of the reference point on the pump relative to a fixed first reference point and/or the second distance change value Δd2 of the reference point on the drive relative to a fixed second reference point. This has the advantage that changes in the position of the pump and/or the drive can be detected by means of the monitoring apparatus according to the invention in relation to the fixed reference point and their size(s) can be quantified. The first and second fixed reference points each refer to a point outside the sprinkler pump unit. The first and second reference points are at different locations, for example, but can alternatively be at the same location.

A further expedient embodiment of the invention is characterised in that the at least one first measuring unit is configured and adapted to determine a first distance value d1 and a second measuring unit is configured and adapted to determine a second distance value d2, and furthermore the evaluation unit is configured and adapted to calculate the first distance change value Δd1 from the difference between the distance value d1 and a predetermined first reference distance value d₀₁ and to calculate the second distance change value Δd2 from the difference between the distance value d2 and a predetermined second reference distance value d₀₂, the evaluation unit being further configured and adapted to compare the first distance value d1 with the first reference distance value d₀₁ and the second distance value d2 with the second reference distance value d₀₂ and, if the inequalities (d₀₁+Δref)<d1<(d₀₁−Δref) and (d₀₂+Δref)<d2<(d₀₂−Δref) are satisfied, to generate the first distance value d1 as a first distance deviation value da1 and/or to generate the second distance value d2 as a second distance deviation value da2 and/or to generate a deviation signal, where Δref is a predetermined reference distance change value. The advantages mentioned in connection with the determination of the distance change values Δd1, Δd2 also apply analogously to the determination of the first and second distance values d1, d2, the only difference being that the distance values denote absolute distances.

A preferred further embodiment of the invention is characterised in that the reference point on the pump and the reference point on the drive are mechanically connected to one another via a flexible, tensile force receiving-resistant load-receiving element, with a free end of the load-receiving element being arranged on the first measuring unit for detecting the position change of at least one of the reference points. Advantageously, it is thus possible to monitor possible position changes of both the reference point on the pump and the reference point on the drive with the first measuring unit, i.e. with a single unit. Metrological complexity is thereby reduced to a minimum and an extremely cost-effective solution is provided by the present invention. Thanks to the flexible, tensile force receiving-resistant load-receiving element, a summation of both possible position changes is achieved through superposition by mechanical means. The respective position changes are included in the summation with a corresponding weighting depending on how the load-receiving element is aligned on the sections between the reference point on the pump and the reference point on the drive as well as between the reference point on the pump or the reference point on the drive and the first measuring unit. The tensile force receiving-resistant load element is understood to be an element that is able to remain dimensionally stable at least when subjected to a tensile force.

According to a further preferred embodiment of the invention, the monitoring apparatus for determining the position change is configured and adapted to determine a cumulative distance change value ΔdS, calculated as a cumulative value from a distance change b1 between the at least one reference point on the pump or the at least one reference point on the drive and the at least one fixed reference point, and a distance change b2 between the pump and the drive, the evaluation unit being further configured and adapted to compare the cumulative distance change value ΔdS with a predefined reference distance change value Δref and, if the inequality |ΔdS|>Δref is satisfied, to generate a deviation signal and/or to generate the cumulative distance change value ΔdS as a third deviation value Δa3. Advantageously, the cumulative value is thus determined, preferably in particular by computation, and if the aforementioned inequality is satisfied, the third deviation value Δa3 is determined as a quantitative cumulative value that reflects the total deviation.

A preferred further embodiment of the invention is characterised in that the at least one measuring unit is configured and adapted to determine a cumulative distance value dS, and furthermore the evaluation unit is configured and adapted to calculate the cumulative distance change value ΔdS from the difference between the cumulative distance value dS and a predetermined third reference distance value d₀₃, the evaluation unit preferably being furthermore configured and adapted to compare the cumulative distance value dS with the third reference distance value d₀₃ and, if the inequality (d₀₃−Δref)>dS>(d₀₃+Δref) is satisfied, to generate a deviation signal and/or to generate the cumulative distance value dS as a third distance deviation value da3. The advantages associated with determining the cumulative distance value dS are analogous to the aforementioned advantages of determining the distance change value ΔdS, the only difference being that the cumulative distance value dS does not quantify a distance change, but reflects the absolute distance. In the context of the present invention, quantification is understood to mean that at least one corresponding numerical value is assigned to the detected distance. The numerical value therefore does not necessarily have to correlate with the distance actually detected but can be defined by a predetermined assignment rule. Advantageously, the numerical value correlates with the detected distance.

A further expedient embodiment of the invention is characterised in that the load-receiving element is arranged in a fixed manner at the reference point on the pump or at the reference point on the drive, while the load-receiving element is arranged at the respective other reference point, namely at the reference point on the drive or on the pump, so as to be movable relative thereto with at least one degree of freedom. Advantageously, position changes of the pump and drive can thus be detected in a particularly simple manner. Because the arrangement is movable with at least one degree of freedom, position changes at the other reference point result in them acting on the first measuring device via the load-receiving element. Similarly, changes in the position of the reference point to which the load-receiving element is fixed also cause these to act on the first measuring device. This achieves mechanical decoupling of the reference points on the pump and drive, but at the same time position changes of both reference points can be detected by means of the first measuring device.

A preferred further development of the invention is characterised in that the load-receiving element is arranged in such a way that it is aligned between the reference points on the pump and the drive in a first direction and between one of the reference points and the first measuring unit in a second direction, the direction vectors of the first and second directions being linearly independent of one another. This has the advantage that the position changes of each of the reference points are included with different weighting factors depending on the respective orientation of the direction vectors.

According to a further preferred embodiment, the load-receiving element is arranged at the respective other reference point by means of a spring element. This means, on the one hand, that the reference points can move independently of each other in the event of a position change and, at the same time, the position change can be detected by a change in the tensile force acting on the load-receiving element by means of the first measuring unit. Additionally, the spring element has the advantage that the load-receiving element is preloaded by spring force. In this way, position changes that both increase and decrease the distance between the respective reference point and the first measuring unit can be detected.

A further expedient embodiment of the invention is characterised in that an eyelet or a roller, through or over which the load-receiving element is guided, is arranged at the respective other reference point. Advantageously, the load element is arranged to be movable at the other reference point at least with the aforementioned one degree of freedom. The advantages mentioned with the arrangement movable with one degree of freedom apply analogously.

A preferred further embodiment of the invention is characterised in that the load-receiving element is in the form of a chain or cable. Such an embodiment of the load-receiving element represents a configuration simple as possible, while at the same time meeting the requirements regarding the necessary tensile stability.

According to a further preferred embodiment of the invention, the load-receiving element is configured to be tenso-elastic. This has the advantage that the load-receiving element also fulfils the function of a spring element.

A further expedient embodiment of the invention is characterised in that the first measuring unit and/or the second measuring unit comprise at least one distance sensor from the following list: load cell sensor, resistive sensor, optical sensor, laser-optical systems, inductive sensor, safety switch. Particularly, the use of load cell sensors has proven to be particularly advantageous, as these convert changes in force and/or displacement into a corresponding electrical signal in order to determine the aforementioned variables relevant to position changes.

The task is further solved by a corresponding arrangement which comprises a monitoring apparatus with the aforementioned features and a control device, the control device being furthermore configured and adapted to automatically generate a start signal for starting a pump test run at a predetermined test start time in order to start the pump, and the control device being configured and adapted to block the start signal for starting the pump test run if a first deviation value and/or a second deviation value exists. This ensures that a pump test run is only started when all components of the sprinkler pump unit are in their specified desired positions, i.e. no significant position change has been detected by the monitoring apparatus according to the invention.

A further expedient embodiment of the invention is characterised in that the control device is configured and adapted to block the start signal for starting the pump test run if a first distance deviation value and/or a second distance deviation value exists. This reliably prevents the pump from starting if a position change has been detected.

A preferred further embodiment of the invention is characterised in that the control unit is configured to block the start signal for starting the pump test run until the control unit is reset by means of a reset signal. In this way, the function of the pump test run is temporarily prevented at least until the control unit is reset by means of the reset signal.

The object is further achieved by the method mentioned at the outset by determining a position change of at least one reference point on the pump and/or the drive relative to at least one fixed reference point by means of the at least one measuring unit.

The advantages that can be achieved with the present invention have already been described in detail above in connection with the apparatus according to the invention and the arrangement according to the invention. To avoid repetition, we refer to the said advantages also in connection with the method according to the invention, which apply in the same way to the method claims which are formulated essentially analogously to the apparatus and the arrangement. Therefore, only selected aspects of the method according to the invention are discussed separately below.

A preferred embodiment of the invention is characterised by determining the position change by determining a first distance change value Δd1 of the at least one reference point on the pump and/or a second distance change value Δd2 of the at least one reference point on the drive in relation to the at least one fixed reference point and comparing the first distance change value Δd1 and/or the second distance change value Δd2 with a predetermined reference distance change value Δref and, if the inequalities |Δd1|>Δref and/or |Δd2|>Δref are satisfied, generating the first distance change value Δd1 as a first deviation value Δa1 and/or the second distance change value Δd2 as a second deviation value Δa2 and/or generating a deviation signal.

A further expedient embodiment of the invention is characterised by determining the first distance change value Δd1 of the reference point on the pump in relation to a fixed first reference point and/or the second distance change value Δd2 of the reference point on the drive in relation to a fixed second reference point.

A further expedient embodiment of the invention is characterised by determining a first distance value d1 by means of the at least one first measuring unit and a second distance value d2 by means of at least one second measuring unit, and furthermore by calculating the first distance change value Δd1 from the difference between the distance value d1 and a predetermined first reference distance value d₀₁ and the second distance change value Δd2 from the difference between the distance value d2 and a predetermined second reference distance value d₀₂ and comparing the first distance value d1 with the first reference distance value d₀₁ and the second distance value d2 with the second reference distance value d₀₂ and, if the inequalities (d₀₁+Δref)<d1<(d₀₁−Δref) and (d₀₂+Δref)<d2<(d₀₂−Δref) are satisfied, generating the first distance value d1 as a first distance deviation value da1 and/or the second distance value d2 as a second distance deviation value da2 and/or generating a deviation signal, where Δref is a predetermined reference distance change value.

According to a further preferred embodiment of the invention, the position change of at least one of the reference points is detected by arranging a free end of the load-receiving element on the first measuring unit and mechanically connecting the reference point on the pump and the reference point on the drive to one another via a flexible, tensile force receiving-resistant load-receiving element.

A further expedient embodiment of the invention is characterised by determining the position change by calculating a cumulative distance change value ΔdS from a distance change b1 between the at least one reference point on the pump or the at least one reference point on the drive and the at least one fixed reference point and a distance change b2 between the pump and the drive and comparing the cumulative distance change value ΔdS with a predetermined reference distance change value Δref and, if the inequality |ΔdS|>Δref is satisfied, generating a deviation signal and/or generating the cumulative distance change value ΔdS as a third deviation value Δa3.

According to a further preferred embodiment, a cumulative distance value dS and a cumulative distance change value ΔdS are calculated from the difference between the cumulative distance value dS and a predetermined third reference distance value, comparing the cumulative distance value dS with the third reference distance value and, if the inequality (d₀₃−Δref)>dS>(d₀₃+Δref) is satisfied, generating a deviation signal and/or generating the cumulative distance value dS as a third distance deviation value da3.

According to a further preferred embodiment of the invention, the load-receiving element is arranged in a fixed manner at the reference point on the pump or at the reference point on the drive, while the load-receiving element is arranged at the respective other reference point, namely at the reference point on the drive or on the pump, so as to be movable relative thereto with at least one degree of freedom.

According to a further preferred embodiment, the load-receiving element is arranged in such a way that it is aligned between the reference points on the pump and the drive in a first direction and between one of the reference points and the first measuring unit in a second direction, the direction vectors of the first and second directions being linearly independent of one another.

A preferred further embodiment of the invention is characterised by operating a sprinkler pump unit, wherein the sprinkler pump unit comprises a drive, a pump and an installation base, the drive being mounted to the installation base by a first mounting and the pump by a second mounting and the installation base being mounted to the floor by a third mounting, and with a monitoring apparatus having the features described above and furthermore with a control device, the control device automatically generating a start signal for starting a pump test run at a predetermined test start time in order to start the pump and, in the presence of a first deviation value and/or a second deviation value, blocking the start signal for starting the pump test run by means of the control device.

### BRIEF DESCRIPTION OF THE DRAWINGS

Further useful and/or advantageous features and embodiments of the invention are described in the dependent claims and the description. Particularly preferred embodiments are explained in more detail with reference to the attached drawing. The drawing shows the following:

FIG. 1 is a schematic representation of a first embodiment of the present invention;

FIG. 2 is a schematic representation of a second embodiment of the present invention;

FIG. 3 is a schematic representation of a third embodiment of the present invention;

FIG. 4 is a schematic representation of a fourth embodiment of the present invention;

FIG. 5 is a schematic representation of a modification of the embodiment shown in FIG. 4; and

FIG. 6 is a front view of the sprinkler pump unit and the monitoring apparatus according to the invention.

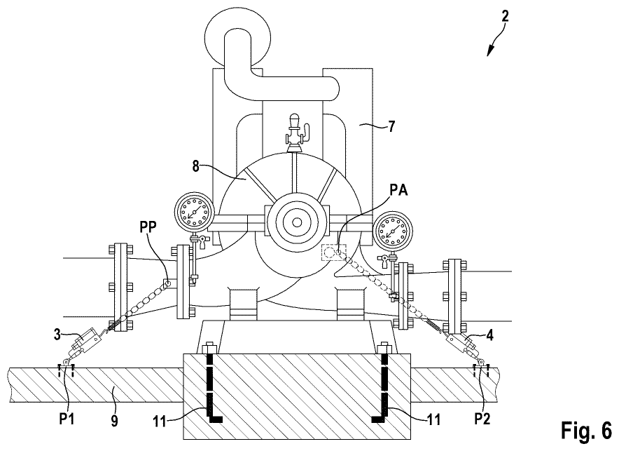

### DETAILED DESCRIPTION OF THE INVENTION

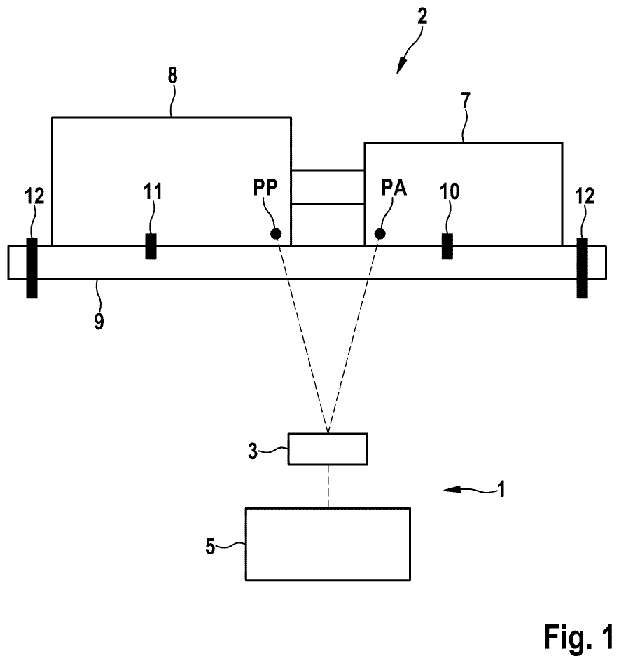

FIG. 1 exemplarily shows a schematic view of the monitoring apparatus 1 and sprinkler pump unit 2 according to the invention. As shown in FIG. 1, this comprises at least one first measuring unit 3 and an evaluation unit 5. The sprinkler pump unit 2 comprises a drive 7, for example an electric motor or a diesel engine, a pump 8 and an installation base 9. The drive 7 is mounted to the installation base 9 by a first mounting 10. The pump 8 is mounted to the installation base 9 by a second mounting 11. The installation base itself is mounted to the floor by a third mounting 12. The mounting is realised for example with bolts (not shown in the figure). It is also possible that the drive 7 and/or the pump 8 is/are mounted directly to the floor.

The monitoring apparatus 1 is preferably configured and adapted to determine a position change of at least one reference point PP, PA on the pump 8 and/or the drive 7 relative to at least one fixed reference point P1, P2, i.e. to a reference point outside the sprinkler pump unit 2, by means of the at least one first measuring unit 3.

Further preferably, the monitoring apparatus 1 is configured and adapted to determine the position change by determining a first distance change value Δd1 of the at least one reference point PP on the pump 8 and/or a second distance change value Δd2 of the at least one reference point PA on the drive 7 in relation to the at least one fixed reference point P1, P2.

Advantageously, the evaluation unit 5 is further configured and adapted to compare the first distance change value Δd1 and/or the second distance change value Δd2 with a predefined reference distance change value Δref. This comparison checks whether the inequalities |Δd1|>Δref and/or |Δd2|>Δref are satisfied in order to then generate the first distance change value Δd1 as a first deviation value Δa1 and/or the second distance change value Δd2 as a second deviation value Δa2 and/or to generate a deviation signal.

Advantageously, the evaluation unit 5 is also adapted to compare the respective distance change values Δd1, Δd2 with a predefined reference value Δref. This reference value Δref thus serves as a threshold value so that small amounts of the distance change values Δd1, Δd2 that are below this value are not evaluated as a positional deviation. Only when the amounts of the distance change values Δd1, Δd2 each exceed the reference value Δref does the evaluation unit 5 evaluate this as a relevant position change and subsequently generate the said distance change values and/or the deviation signal.

A further expedient embodiment of the invention is characterised in that the monitoring apparatus 1 is adapted to determine the first distance change value Δd1 of the reference point PP on the pump 8 relative to a fixed first reference point P1 and/or the second distance change value Δd2 of the reference point PA on the drive 7 relative to a fixed second reference point P2. The first and second fixed reference points P1, P2 each refer to a point outside the sprinkler pump unit 2. The first and second reference points are at different locations, for example, or at one and the same location.

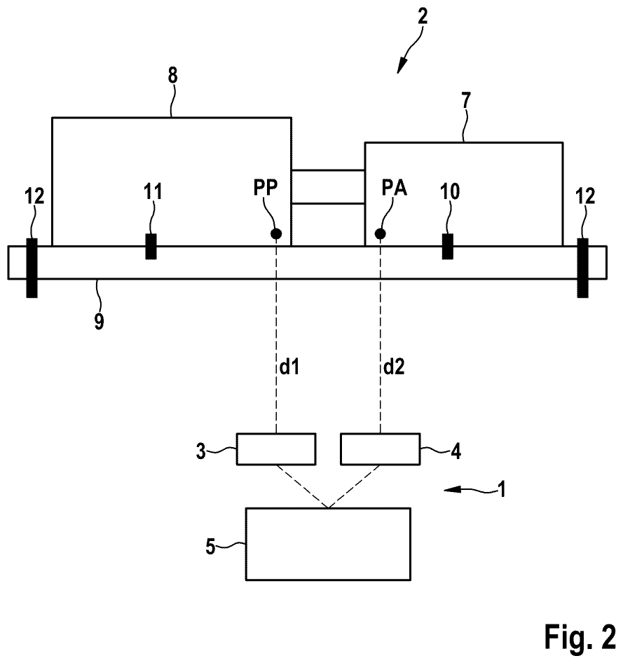

Further preferably—as can be seen from the embodiment shown in FIG. 2—the at least one first measuring unit 3 is adapted to determine a first distance value d1 and a second measuring unit 4 is configured to determine a second distance value d2. Furthermore, the evaluation unit 5 is configured and adapted to calculate the first distance change value Δd1 from the difference between the distance value d1 and a predetermined first reference distance value d₀₁ and the second distance change value Δd2 from the difference between the distance value d2 and a predetermined second reference distance value d₀₂. The evaluation unit 5 is further configured and adapted to compare the first distance value d1 with the first reference distance value d₀₁ and the second distance value d2 with the second reference distance value d₀₂. If the inequalities

$$( {d}_{01} + Δ ref ) < d 1 < ( {d}_{01} - Δ ref ) and$$

$$( {d}_{02} + Δ ref ) < d 2 < ( {d}_{02} - Δ ref )$$

are satisfied, the first distance value d1 is generated as a first distance deviation value da1 and/or the second distance value d2 is generated as a second distance deviation value da2 by means of the evaluation unit 5 and/or a deviation signal is generated. The variable Δref denotes a predefined reference distance change value.

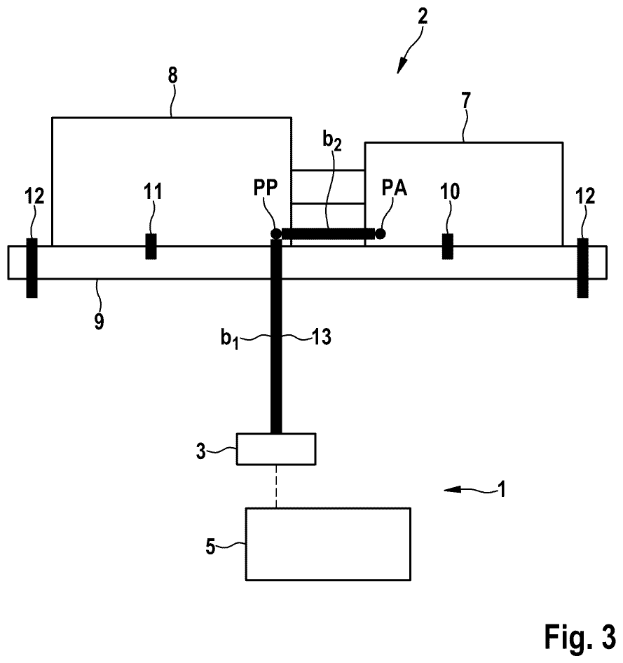

A third embodiment of the invention is shown in FIG. 3. As can be seen, the reference point PP on the pump 8 and the reference point PA on the drive 7 are mechanically connected to each other via a flexible, tensile force receiving-resistant load-receiving element 13. A free end of the load-receiving element 13 is arranged on the first measuring unit 3 for detecting the position change of at least one of the reference points PP, PA.

The monitoring apparatus for determining the position change is preferably configured and adapted to determine a cumulative distance change value ΔdS, calculated as a total value from a distance change b1 between the at least one reference point PP on the pump 8 or the at least one reference point PA on the drive 7 and the at least one fixed reference point P1, P2, and a distance change b2 between the pump 8 and the drive 7. The evaluation unit 5 is also adapted to compare the cumulative distance change value ΔdS with a predefined reference distance change value Δref and to generate a deviation signal if the inequality |ΔdS| >Δref is satisfied and/or to generate the cumulative distance change value ΔdS as a third deviation value Δa3.

Further preferably, the at least one measuring unit 3, 4 is configured to determine a cumulative distance value dS. For this purpose, the evaluation unit 5 is adapted to calculate the cumulative distance change value ΔdS from the difference between the cumulative distance value dS and a specified third reference distance value d₀₃. The evaluation unit is also configured and adapted to compare the cumulative distance value dS with the third reference distance value d₀₃ and, if the inequality (d₀₃−Δref)>dS>(d₀₃+Δref) is satisfied, to generate a deviation signal and/or to generate the cumulative distance value dS as a third distance deviation value da3.

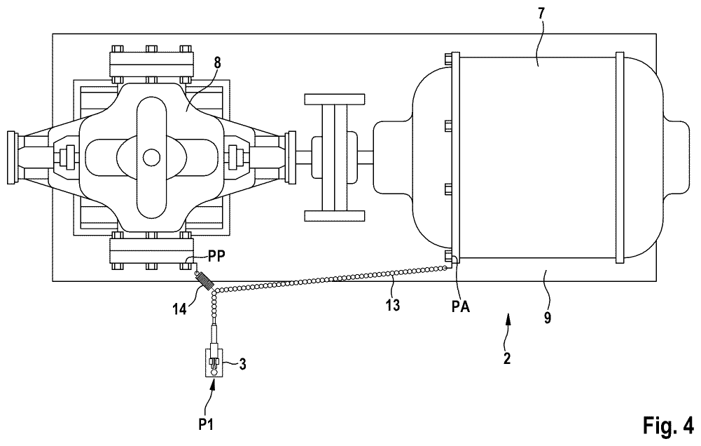

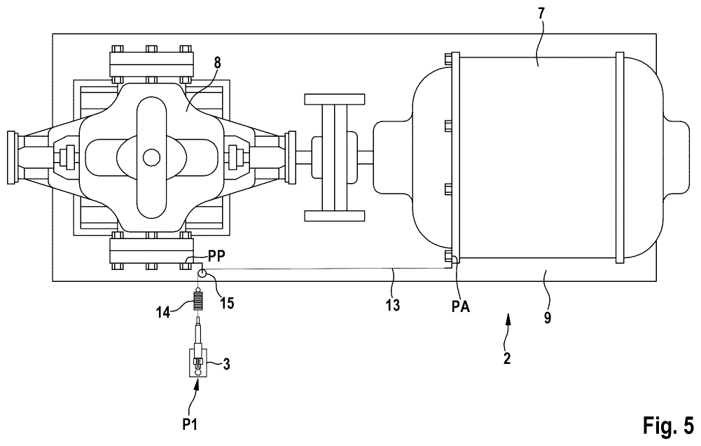

As shown in FIGS. 4 and 5, the load-receiving element 13 is preferably fixedly arranged at the reference point PP on the pump 8 or at the reference point PA on the drive 7. The load-receiving element 13, on the other hand, is arranged at the respective other reference point PA, PP, namely at the reference point PA on the drive 7 or on the pump 8, so as to be movable relative thereto with at least one degree of freedom.

As can be seen from FIGS. 4 and 5, the load-receiving element 13 is preferably arranged such that it is aligned between the reference points PP, PA on the pump 8 and the drive 7 in a first direction and between one of the reference points PA, PP and the first measuring unit 3 in a second direction. The direction vectors of the first and second directions are also preferably linearly independent of one another.

As shown by way of example in FIG. 4, the load-receiving element 13 is arranged at the respective other reference point PP by means of a spring element 14. Further preferably, as can be seen in FIG. 5, an eyelet 15 or a roller 15, through or over which the load-receiving element 13 is arranged in a guided manner, is arranged at the respective other reference point PP.

A preferred further embodiment of the invention is characterised in that the load-receiving element 13 is in the form of a chain or cable. Further preferably, the load-receiving element 13 is configured to be tenso-elastic.

The first measuring unit 3 and/or the second measuring unit 4 each comprise at least one distance sensor. The distance sensors are configured, for example, as load cell sensors, resistive sensors, optical sensors, laser-optical systems, inductive sensors or safety switches and are adapted to provide the distance between the aforementioned respective reference points PP, PA, P1, P2 by supplying an electrical signal corresponding to the distance. This correspondence is preferably adapted such that the corresponding electrical signal is assigned to a respective distance variable. However, it is also possible that the correspondence is given by a representative measured variable, which can be used to draw qualitative conclusions about the distance and/or a distance change.

As mentioned at the outset, the invention also comprises an arrangement with the sprinkler pump unit 2 described above. The arrangement according to the invention also comprises a control unit—not shown in detail in the drawing—which is also referred to as a control device. The control device can be a separate device or part of the evaluation unit 5. It is also possible for the evaluation unit 5 to be part of the control unit or control device.

The control device is preferably configured to automatically generate a start signal to start a pump test run at a predetermined test start time in order to start the pump 8 or its drive 7. The control unit is furthermore configured and adapted to block the start signal for starting the pump test run if the first deviation value Δa1 and/or the second deviation value Δa2 exists.

Further preferably, the control unit is configured and adapted to block the start signal for starting the pump test run if the first distance deviation value da1 and/or the second distance deviation value da2 exists.

The control unit is preferably configured to block the start signal for starting the pump test run until the control unit is reset by means of a reset signal. In this way, the function of the pump test run is temporarily prevented at least until the control unit is reset by means of the reset signal.

The invention also comprises the method mentioned at the outset, which is characterised by determining a position change of at least one reference point PP, PA on the pump 8 and/or the drive 7 relative to at least one fixed reference point P1, P2 by means of the at least one measuring unit 3, 4.

Concerning the further embodiments of the method according to the invention, in order to avoid repetition, reference is made to our comments above concerning the monitoring apparatus 1 according to the invention. All information about the monitoring apparatus 1 also applies analogously to the method according to the invention.

Where load cells are used as first and second measuring units 3, 4, it is particularly preferable that the respective connections to the reference points PP, PA are spring-loaded. It is also possible for these connections to include adjusting elements by means of which they are subjected to an adjustable spring preload. On the one hand, such preloading serves to compensate for possible temperature drift due to lengthening or shortening of the respective connecting means between the respective measuring unit 3, 4 and the aforementioned reference points PP, PA. A further advantage is that a preload force is always applied to the load cell due to the preload, so that both an increase in distance and a decrease in distance can be reliably detected and monitored. In particular, it is thus also possible to detect a deviation from the rest position or zero position, i.e. a distance change that occurs, qualitatively, without quantifying the size of this distance change.

We claim:

1. A monitoring apparatus for a sprinkler pump unit, comprising:
at least one first measuring unit; and
an evaluation unit;
wherein the sprinkler pump unit comprises a drive, a pump and an installation base, the drive being mounted to the installation base by a first mounting, the pump being mounted to the installation base by a second mounting, and the installation base being mounted to a floor by a third mounting; and
wherein the monitoring apparatus is configured and adapted to determine a position change of at least one reference point on the pump and/or the drive relative to at least one fixed reference point by the at least one first measuring unit.

2. The monitoring apparatus according to claim 1, wherein the monitoring apparatus for determining the position change is configured and adapted to determine a first distance change value Δd1 of the at least one reference point on the pump and/or a second distance change value Δd2 of the at least one reference point on the drive relative to the at least one fixed reference point, the evaluation unit being further configured and adapted to compare the first distance change value Δd1 and/or the second distance change value Δd2 with a predetermined reference distance change value Δref, and when the inequalities
$$\vert Δ d 1 \vert > Δ ref and / or \vert Δ d 2 \vert > Δ ref$$
are satisfied, to generate the first distance change value Δd1 as a first deviation value Δa1 and/or the second distance change value Δd2 as a second deviation value Δa2 and/or to generate a deviation signal (S_{A1}).

3. The monitoring apparatus according to claim 2, wherein the monitoring apparatus is adapted to determine the first distance change value Δd1 of the reference point on the pump relative to a fixed first reference point and/or the second distance change value Δd2 of the reference point on the drive relative to a fixed second reference point.

4. The monitoring apparatus according to claim 2, wherein:
the at least one first measuring unit is configured and adapted to determine a first distance value d1 and a second measuring unit is configured and adapted to determine a second distance value d2; and
the evaluation unit is configured and adapted to calculate the first distance change value Δd1 from a difference between the distance value d1 and a predetermined first reference distance value d₀₁ and the second distance change value Δd2 from a difference between the distance value d2 and a predetermined second reference distance value d₀₂; and
the evaluation unit further being configured and adapted to compare the first distance value d1 with the first reference distance value d₀₁ and the second distance value d2 with the second reference distance value d₀₂ and, when the inequalities
$$( {d}_{01} + Δ ref ) < d 1 < ( {d}_{01} - Δ ref ) and$$
$$( {d}_{02} + Δ ref ) < d 2 < ( {d}_{02} - Δ ref )$$
are satisfied, to generate the first distance value d1 as a first distance deviation value da1 and/or the second distance value d2 as a second distance deviation value da2 and/or a deviation signal (S_{A1}), where Δref is a predetermined reference distance change value.

5. The monitoring apparatus according to claim 1, wherein the reference point on the pump and the reference point on the drive are mechanically connected to one another via a flexible, tensile force receiving-resistant load-receiving element, with a free end of the load-receiving element being arranged on the at least one first measuring unit for detecting the position change of at least one of the reference points.

6. The monitoring apparatus according to claim 5, wherein the monitoring apparatus for determining the position change is configured and adapted to determine a cumulative distance change value ΔdS, calculated as a cumulative value from a distance change b1 between the at least one reference point on the pump or the at least one reference point on the drive and the at least one fixed reference point, and a distance change b2 between the pump and the drive, the evaluation unit being further configured and adapted to compare the cumulative distance change value ΔdS with a predefined reference distance change value Δref and, when the inequality |ΔdS|>Δref is satisfied, to generate a deviation signal (S_{A3}) and/or to generate the cumulative distance change value ΔdS as a third deviation value Δa3.

7. The monitoring apparatus according to claim 6, wherein the at least one measuring unit is configured and adapted to determine a cumulative distance value dS, and the evaluation unit is configured and adapted to calculate the cumulative distance change value ΔdS from the difference between the cumulative distance value dS and a predetermined third reference distance value d₀₃, the evaluation unit being further configured and adapted to compare the cumulative distance value dS with the third reference distance value d₀₃ and, if the inequality
$$( {d}_{03} - Δ ref ) > dS > ( {d}_{03} + Δ ref )$$
is satisfied, to generate a deviation signal (S_{A1}) and/or to generate the cumulative distance value dS as a third distance deviation value da3.

8. The monitoring apparatus according to claim 5, wherein the load-receiving element is arranged in a fixed manner at the reference point on the pump or at the reference point on the drive, while the load-receiving element) is arranged at the respective other reference point, namely at the reference point on the drive or on the pump, so as to be movable relative thereto with at least one degree of freedom.

9. The monitoring apparatus according to claim 8, wherein the load-receiving element is arranged in such a way that it is aligned between the reference points on the pump and the drive in a first direction and between one of the reference points and the first measuring unit in a second direction, direction vectors of the first and second directions being linearly independent of one another.

10. The monitoring apparatus according to claim 8, wherein the load-receiving element is arranged at the respective other reference point by a spring element.

11. The monitoring apparatus according to claim 9, wherein an eyelet or a roller, through or over which the load-receiving element is guided, is arranged at the respective other reference point.

12. The monitoring apparatus according to claim 5, wherein the load-receiving element is in the form of a chain or cable.

13. The monitoring apparatus according to claim 5, wherein the load-receiving element is configured to be tenso-elastic.

14. The monitoring apparatus according to claim 1, wherein the at least one first measuring unit and/or the second measuring unit comprise at least one distance sensor from the following list: load cell sensor, resistive sensor, optical sensor, laser-optical systems, inductive sensor, safety switch.

15. An arrangement, comprising:
a sprinkler pump unit having a drive, a pump and an installation base, the drive being mounted to the installation base by a first mounting, the pump being mounted to the installation base by a second mounting, and the installation base being mounted to a floor by a third mounting;
a monitoring apparatus according to claim 1; and
a control device configured and adapted to automatically generate a start signal (Sₜₑₛₜ) for starting a pump test run at a predetermined test start time (tₜₑₛₜ) and, in a presence of a first deviation value (Δa1) and/or a second deviation value (Δa2), to block the start signal (Sₜₑₛₜ) for starting the pump test run.

16. The arrangement according to claim 15, wherein the control device is configured and adapted to block the start signal (Sₜₑₛₜ) for starting the pump test run when a first distance deviation value (da1) and/or a second distance deviation value (da2) exists.

17. The arrangement according to claim 15, wherein the control unit is configured to block the start signal (Sₜₑₛₜ) for starting the pump test run until the control unit (6) is reset by a reset signal.

18. A method for monitoring a sprinkler pump unit with a monitoring apparatus, the monitoring apparatus comprising at least one first measuring unit and an evaluation unit, the sprinkler pump unit comprising a drive, a pump and an installation base, the drive being mounted to the installation base by a first mounting, the pump being mounted to the installation base by a second mounting, and the installation base being mounted to a floor by a third mounting, the method comprising:
determining a position change of at least one reference point on the pump and/or the drive relative to at least one fixed reference point by the at least one measuring unit.

19. The method according to claim 18, wherein determining the position change comprises determining a first distance change value Δd1 of the at least one reference point on the pump and/or a second distance change value Δd2 of the at least one reference point on the drive relative to the at least one fixed reference point and comparing the first distance change value Δd1 and/or the second distance change value Δd2 with a predetermined reference distance change value Δref, and when the inequalities
$$\vert Δ d 1 \vert > Δ ref and / or \vert Δ d 2 \vert > Δ ref$$
are satisfied, generating the first distance change value Δd1 as a first deviation value Δa1 and/or the second distance change value Δd2 as a second deviation value Δa2 and/or generating a deviation signal (S_{A1}).

20. The method according to claim 19, wherein the determining the first distance change value Δd1 of the reference point on the pump is relative to a fixed first reference point and/or the second distance change value Δd2 of the reference point on the drive is relative to a fixed second reference point.

21. The method according to claim 19, wherein:
the determining the first distance value is by the at least one first measuring unit and the second distance value is by at least one second measuring unit;
determining the first distance change value is by calculating the first distance change value from a difference between a distance value d1 and a predetermined first reference distance value d₀₁ and the second distance change value Δd2 from a difference between a distance value d2 and a predetermined second reference distance value d₀₂ and comparing the first distance value d1 with the first reference distance value d₀₁ and the second distance value d2 with the second reference distance value d₀₂ and, when the inequalities
$$( {d}_{01} + Δ ref ) < d 1 < ( {d}_{01} - Δ ref ) and$$
$$( {d}_{02} + Δ ref ) < d 2 < ( {d}_{02} - Δ ref )$$
are satisfied, generating the first distance value d1 as a first distance deviation value da1 and/or the second distance value d2 as a second distance deviation value da2 and/or a deviation signal (S_{A1}), where Δref is a predetermined reference distance change value.

22. The method according to claim 18, wherein detecting the position change of at least one of the reference points is by arranging a free end of a load-receiving element on the first measuring unit and mechanically connecting the reference point on the pump and the reference point on the drive to one another via the load-receiving element comprising a flexible, tensile force receiving-resistant load-receiving element.

23. The method according to claim 22, wherein determining the position change is by calculating a cumulative distance change value ΔdS from a distance change b1 between the at least one reference point on the pump or the at least one reference point on the drive and the at least one fixed reference point and a distance change b2 between the pump and the drive and comparing a cumulative distance change value ΔdS with a predetermined reference distance change value Δref and, when the inequality |ΔdS|>Δref is satisfied, generating a deviation signal (S_{A3}) and/or generating the cumulative distance change value ΔdS as a third deviation value Δa3.

24. The method according to claim 23, wherein the calculating the cumulative distance value dS and calculating the cumulative distance change value ΔdS is from a difference between the cumulative distance value dS and a predetermined third reference distance value (d₀₃), comparing the cumulative distance value dS with the third reference distance value (d₀₃) and, when the inequality
$$( {d}_{03} - Δ ref ) > dS > ( {d}_{03} + Δ ref )$$
is satisfied, generating a deviation signal (S_{A1}) and/or generating the cumulative distance value dS as a third distance deviation value da3.

25. The method according to claim 22, wherein the load-receiving element is arranged in a fixed manner at the reference point on the pump or at the reference point on the drive, while the load-receiving element is arranged at the respective other reference point, namely at the reference point on the drive or on the pump, so as to be movable relative thereto with at least one degree of freedom.

26. The method according to claim 25, wherein the load-receiving element is arranged in such a way that it is aligned between the reference points on the pump and the drive in a first direction and between one of the reference points and the first measuring unit in a second direction, direction vectors of the first and second directions being linearly independent of one another.

27. A method for operating a sprinkler pump unit, wherein the sprinkler pump unit comprising a drive, a pump and an installation base, the drive being mounted to the installation base by a first mounting, the pump being mounted to the installation base by a second mounting, and the installation base being mounted to a floor by a third mounting, the method comprising:
providing a monitoring apparatus according to claim 1 and a control device; and
the control device automatically generating a start signal (Sₜₑₛₜ) for starting a pump test run at a predetermined test start time (tₜₑₛₜ) in order to start the pump and, in the presence of a first deviation value (Δa1) and/or a second deviation value (Δa2), blocking the start signal (Sₜₑₛₜ) for starting the pump test run by the control device.
